(19) United States
(12) Patent Application Publication
(10) Pub. No.: US 2017/0171592 A1
(43) Pub. Date: Jun. 15, 2017

(54) Method and electronic apparatus for adjusting viewing angle of Smart Television playing panorama videos

(71) Applicants: Le Holdings (Beijing) Co., Ltd., Beijing (CN); LE SHI INTERNET INFORMATION TECHNOLOGY CORP. BEIJING, Beijing (CN)

(72) Inventor: Shiwang Cui, Beijing (CN)

(21) Appl. No.: 15/247,691

(22) Filed: Aug. 25, 2016

Related U.S. Application Data
(63) Continuation-in-part of application No. PCT/CN2016/088505, filed on Jul. 5, 2016.

(30) Foreign Application Priority Data
Dec. 10, 2015 (CN) 201510918111.5

(51) Int. Cl. H04N 21/422; H04N 21/472; G06F 3/0488; H04N 21/81

(52) U.S. Cl. CPC H04N 21/4222; H04N 21/816; H04N 21/42224; H04N 21/47205; G06F 3/04883; H04N 21/42222

(57) ABSTRACT

Disclosed are a method and a electronic apparatus of adjusting a viewing angle of a smart television playing panorama videos, wherein the method is applied to a terminal apparatus and includes: displaying a touch control region for adjusting the viewing angle when opening an application program for controlling the smart television is detected; detecting a handed gesture input onto the touch control region to determine a viewing angle adjustment parameter corresponding to the detected handed gesture input; sending the viewing angle adjustment parameter to the smart television by communication with the smart television, so as to adjust the viewing angle. The disclosure uses a smart television with bluetooth and wifi communication functions to connect to the internet, and adjusts a panoramic play parameter of the smart television via a terminal apparatus communicating with the smart television.

### CROSS REFERENCE TO RELATED APPLICATIONS

This application is a continuation of International Application No. PCT/CN2016/088505, filed on Jul. 5, 2016, which is based upon and claims priority to Chinese Patent Application No. 201510918111.5, filed on Dec. 10, 2015, the entire contents of which are incorporated herein by reference.

### TECHNICAL FIELD

The disclosure relates to a smart television field, more particularly to a method and a electronic apparatus for adjusting the viewing angle of a smart television playing a panorama video.

### BACKGROUND

Traditional televisions and modern smart televisions can play general television programs. Android mobile phones using Android OS as terminals have been able to play panorama videos and most of smart television terminals are based on Android OS, so smart televisions are empowered with the live broadcasting and requesting functions of panorama videos under Android OS. For a traditional TV, the human-machine interaction is carried out by only a remote controller (e.g. a typical infrared remote controller for switching TV programs). When smart televisions are empowered with an Android panorama display function, their panorama viewing angle parameter can not be adjusted by a general remote controller. On the other hand, with the population of smart televisions and routers, smart televisions can connect to a network, and with the population of bluetooth, it becomes easier to connect televisions and other terminal apparatuses (e.g. smart phones) together. However, mobile phones now can only play a rule of TV remote controller to switch simple TV programs but cannot give a further control (e.g. switching, magnifying and minifying the viewing angle as a panorama video is played) to a smart television playing a panorama video.

### SUMMARY

In the light of this, the disclosure provides a smart television and an operation terminal, and a method of adjusting the viewing angle of a smart television to resolve the technical problem in the art that it is inconvenient to adjust the viewing angle of a smart television when a panorama video is played.

To resolve the above technical problems, the disclosure provides a method of adjusting a viewing angle of a smart television playing a panorama video, and the method is applied to terminal apparatus and includes steps of:
displaying a touch control region for adjusting the viewing angle when opening an application program for controlling the smart television is detected;
detecting a handed gesture input onto the touch control region to determine a viewing angle adjustment parameter corresponding to the detected handed gesture input; and
sending the viewing angle adjustment parameter to the smart television by communication with the smart television, so as to adjust the viewing angle.

The disclosure further provides a method of adjusting a viewing angle of a smart television playing a panorama video, and the method is applied to terminal apparatus and includes steps of:
detecting whether a gyroscope of the terminal apparatus is enabled when opening an application program for controlling the smart television is detected;
acquiring a parameter from the gyroscope when the gyroscope is enabled;
determining a movement direction of the terminal apparatus according to variances in the parameter acquired from the gyroscope;
generating a viewing angle adjustment parameter for adjusting the viewing angle in a direction corresponding to the movement direction; and
sending the viewing angle adjustment parameter to the smart television by communication with the smart television, so as to adjust the viewing angle.

Embodiments of the present application provide a non-volatile computer storage medium storing computer-executable instructions that are configured to execute the method of adjusting the viewing angle of a smart television playing a panorama video as any of the described above.

Embodiments of the present application provide another non-volatile computer storage medium storing computer-executable instructions that are configured to execute the method of adjusting the viewing angle of a smart television playing a panorama video as any of the described above.

The disclosure further provides an electronic apparatus of adjusting the viewing angle of a smart television playing a panorama video, and the electronic apparatus includes: at least one processor; and a memory; wherein, the memory stores a program executable by the at least one processor to execute steps of:
displaying a touch control region for adjusting the viewing angle when opening an application program for controlling the smart television is detected;
detecting a handed gesture input in the touch control region to determine a viewing angle adjustment parameter corresponding to the detected handed gesture input;
sending the viewing angle adjustment parameter to the smart television via a communication with the smart television to adjust the viewing angle.

The disclosure further provides an electronic apparatus of adjusting the viewing angle of a smart television playing a panorama video, and the electronic apparatus includes: at least one processor; and a memory; wherein, the memory stores a program executable by the at least one processor to execute steps of:
detecting whether a gyroscope of the terminal apparatus is enabled when opening an application program for controlling the smart television is detected;
acquiring a gyroscope parameter when the gyroscope of the terminal apparatus is enabled;
determining a movement direction of the terminal apparatus according to variances in the gyroscope parameter;
generating a viewing angle adjustment parameter for adjusting the viewing angle according to the movement direction;
sending the viewing angle adjustment parameter to the smart television via a communication with the smart television to adjust the viewing angle.

The present application also discloses a mobile terminal characterized by including the electronic apparatus and non-volatile computer storage medium of adjusting the viewing angle of a smart television playing a panorama video as any of the described above.

The method and electronic apparatus of adjusting the viewing angle of a smart television playing a panorama video, provided in the disclosure, adjust a panorama play parameter of the smart television through the communication (e.g. bluetooth communication and wifi connecting the internet) between a terminal apparatus and the smart television by the terminal apparatus communicating with the smart television. Though exemplarily designing a related mobile phone APP (e.g. smart phone APP), when a user needs to adjust the viewing angle of a smart television during playing, the user can use the APP to define a regional screen as a touch pad to do single-finger and multi-finger operations or can use a gyroscope of a terminal apparatus; after touch and gyroscope parameters are obtained, they are transmitted to the smart television through wifi and the bluetooth technology; the smart television will adjust the viewing angle of a panorama model in a panorama video play interface when receiving the parameters; and thus, adjusting the viewing angle of a television screen by the control of the terminal apparatus can be carried out when panoramas are played. The method of adjusting the panoramic play of a smart television in the disclosure is based on live broadcasting and demand systems of a smart television terminal for playing panorama videos so that adjusting the viewing angle of panoramic play and zooming in and zooming out images can be carried out by a touch screen or/and a gyroscope of a terminal apparatus.

It should be understood that both the foregoing general description and the following detailed description are exemplary and explanatory only and do not limit the disclosure.

### BRIEF DESCRIPTION OF THE DRAWINGS

To illustrate the technical solutions in the embodiments of the present invention more clearly, the following briefly introduces the accompanying drawings required for describing the embodiments. Apparently, one or more embodiments in the following description are illustrated by way of example and not by limitation, wherein in the figures of the accompanying drawings, elements having the same reference numeral designations represent like elements throughout. The drawings are not to scale, unless otherwise disclosed.

FIG. 1 is a flow chart of a method of adjusting the viewing angle of a smart television playing a panorama video in accordance with some embodiments.

FIG. 2 is a flow chart of the Embodiment 1.

FIG. 3 is a flow chart of the Embodiment 2.

FIG. 4 is a flow chart of the Embodiment 3.

FIG. 5 is a flow chart of the Embodiment 4.

FIG. 6 is a flow chart of the Embodiment 5.

FIG. 7 is a flow chart of the Embodiment 6.

FIG. 8 is a flow chart of the Embodiment 9.

FIG. 9 is a flow chart of the Embodiment 10.

FIG. 10 is a structural diagram of the Embodiment 13.

FIG. 11 is a structural diagram of the Embodiment 14.

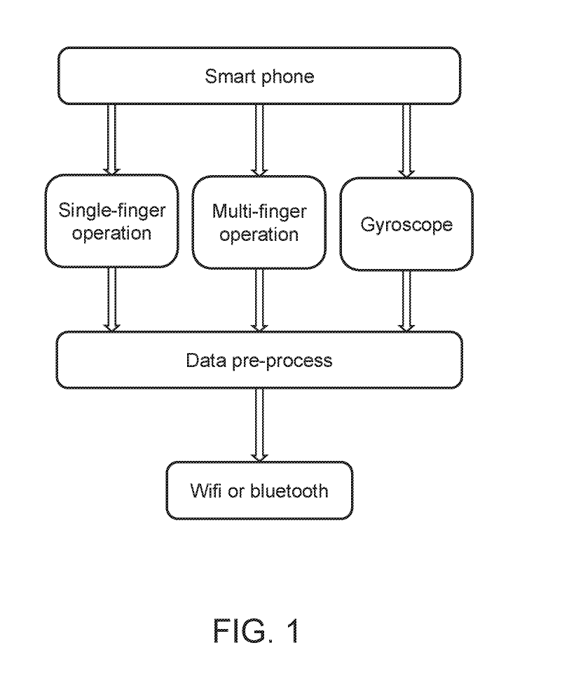

Numeral labels in the figures include: 10 representing a terminal apparatus, 1 representing a touch control region display module, 2 representing a handed gesture input detecting module, 3 representing a parameter transmission module, 4 representing a gyroscope detecting module, and 20 representing a smart television.

The apparent embodiments of the present disclosure are illustrated by the above-mentioned drawings, and detailed descriptions will be given hereinafter. These drawings and text description are not for limiting the scope of conceiving the present disclosure in any way, but for illustrating the concept of the present disclosure for those skilled in the art by referring to specific embodiments.

### DETAILED DESCRIPTION

To make the objectives, technical solutions, and advantages of the embodiments of the present invention more comprehensible, the following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

A panorama video is a video with a 360° viewing angle, is characterized by three-dimension and reality, and can provide users with wonderful visual experiences. Modern technologies have empowered smart televisions to play panorama videos, and panoramic channels have been available on internet protocol televisions.

### Embodiment 1

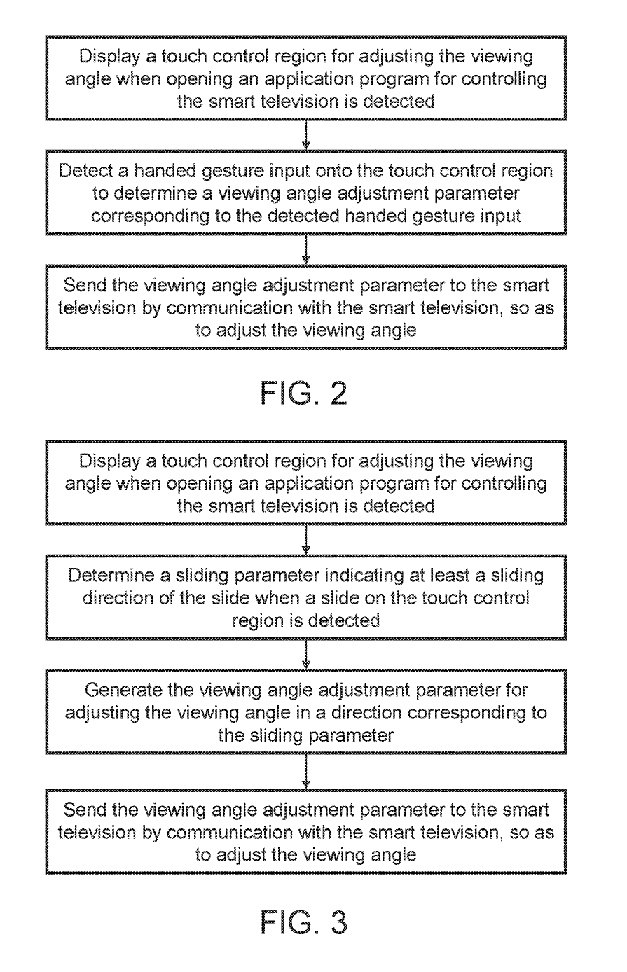

As shown in FIG. 2, a method for adjusting the viewing angle of a smart television playing a panorama video in this embodiment is applied to terminal apparatus and includes steps of:
the terminal apparatus displaying a touch control region for adjusting the viewing angle when opening an application program, e.g. mobile phone APP, installed in the smart television is detected;
detecting a handed gesture input onto the touch control region to determine a viewing angle adjustment parameter corresponding to the detected handed gesture input; and
sending the viewing angle adjustment parameter to the smart television by the communication with the smart television, so as to adjust the viewing angle.

In the foregoing method, the smart television is empowered to play panorama videos, and the smart television can communicate with the terminal apparatus through their connection. The above communication may be carried out by bluetooth communication or by connecting to the internet though Wifi. For example, both the terminal apparatus and the smart television are linked to the network through the TCP point-to-point communication between the smart television and the terminal apparatus, and the present port of the terminal apparatus is monitored for receiving a control parameter from the terminal apparatus. In the method in this embodiment, when a user tries to adjust the viewing angle of the smart television, an application program may be executed to define a screen region as a touch control region for a handed gesture input such as a single finger gesture or a multi-finger (i.e. two or more than two fingers) gesture, determine a viewing angle adjustment parameter corresponding to the detected handed gesture input after obtaining a touch parameter, and send the viewing angle adjustment parameter to the smart television through WiFi or bluetooth technology so that the smart television will adjust the viewing angle of the panoramic model via a panorama video play interface according to the viewing angle adjustment parameter. In this way, the terminal apparatus can carry out the adjustment of the viewing angle of the TV screen playing panoramic images.

### Embodiment 2

As shown in FIG. 3, a method for adjusting the viewing angle of a smart television playing a panorama video in this embodiment is similar to the method in the Embodiment 1, and however, the step of detecting the handed gesture input onto the touch control region to determine the viewing angle adjustment parameter corresponding to the detected handed gesture input particularly includes steps of:
determining a sliding parameter indicating at least the sliding direction of the slide when a slide on the touch control region is detected; and
generating the viewing angle adjustment parameter for adjusting the viewing angle in a direction corresponding to the sliding parameter,
wherein the sliding parameter may further indicate the sliding speed, sliding distance, and so on.

This embodiment adjusts the viewing angle of playing the panorama video according to a slide done onto the touch control region. For example, when the user uses a single finger to slide up and down, left and right on the touch screen, the touch screen will obtain a parameter related to this single finger gesture. This single finger gesture corresponds to the control of up and down, left and right shifting the viewing angle of the panoramic model. After the sliding direction is confirmed, a preset adjustment parameter indicating a direction that is the same as or opposite to the sliding direction is produced. For example, the viewing angle may be adjusted according to the preset adjusting strength (e.g. the preset adjusting strength is 5 or 10 degrees, and whenever a left slide is detected, the panorama viewing angle will be left rotated by 5 or 10 degrees or right rotated by 5 or 10 degrees; and a right, upward or downward slide has a similar adjustment manner for the viewing angle), or may be adjusted by detecting a sliding distance or speed and then determining a adjustment parameter according to the sliding distance or speed (e.g. the faster the sliding speed or the longer the sliding distance, the larger the adjustment parameter). The method in this embodiment has flexibility of adjustment, and users may obtain good interaction experiences.

### Embodiment 3

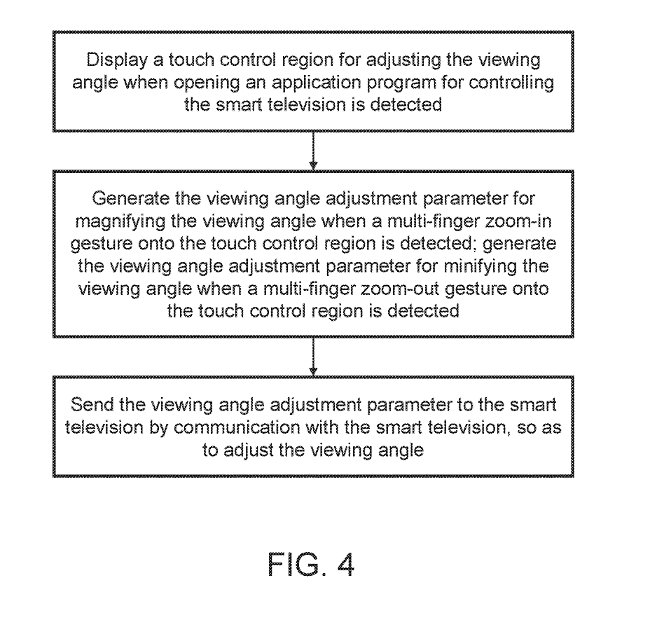

As shown in FIG. 4, a method for adjusting the viewing angle of a smart television playing a panorama video in this embodiment is similar to the method in the Embodiment 1, and however, the step of detecting the handed gesture input onto the touch control region to determine the viewing angle adjustment parameter corresponding to the detected handed gesture input particularly includes steps of:
generating the viewing angle adjustment parameter for magnifying the viewing angle when a multi-finger (i.e. two or more than two fingers) zoom-in gesture onto the touch control region is detected; and
generating the viewing angle adjustment parameter for minifying the viewing angle when a multi-finger (i.e. two or more than two fingers) zoom-out gesture onto the touch control region is detected.

This embodiment adjusts the viewing angle of playing panorama videos according to a multi-finger gesture done onto the touch control region. For example, a multi-finger gesture is a multi-finger zoom-out gesture or a multi-finger zoom-in gesture; when a multi-finger zoom-out gesture is sensed, the viewing angle of playing panorama videos will be zoomed in so that the user will see an enlarged space of a wider viewing angle on TV; and when a multi-finger zoom-in gesture is sensed, the viewing angle of playing panorama videos will be zoomed out so that the user will see a shrank space of a narrower viewing angle on TV. Moreover, a magnification or a minification of the viewing angle may be adjusted according to the strength of a multi-finger operation as well as the preset strength, or may be adjusted according to a ratio of an coordinate of starting a multi-finger operation to a coordinate of finishing the multi-finger operation (i.e. the initial distance between two fingers to the final distance between the two fingers). Therefore, the method in this embodiment has flexibility of adjustment, and users may obtain good interaction experiences.

### Embodiment 4

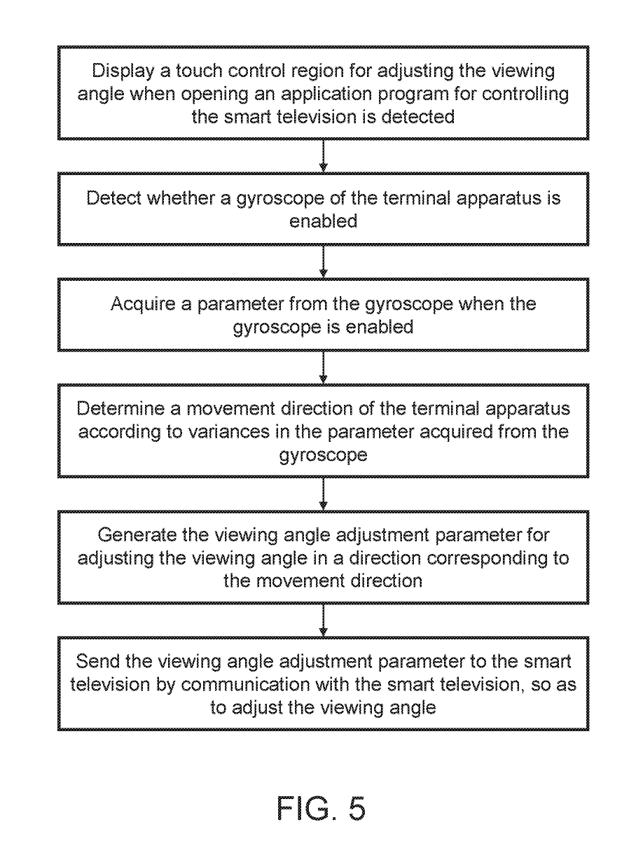

As shown in FIG. 5, a method for adjusting the viewing angle of a smart television playing a panorama video in this embodiment is similar to the method in the Embodiment 1, and however, after the step of displaying the touch control region for adjusting the viewing angle when opening the application program is detected, the method further includes steps of:
acquiring a parameter from a gyroscope of the terminal apparatus when the gyroscope is enabled;
determining the movement direction of the terminal apparatus according to variances in the parameter acquired from the gyroscope;
generating the viewing angle adjustment parameter for adjusting the viewing angle in a direction corresponding to the movement direction.

In this embodiment, the viewing angle is adjusted by the change in the gyroscope parameter caused by moving the terminal apparatus. For example, when the user moves up and down the terminal apparatus, the gyroscope parameter will change so that the viewing angle of playing the panorama video will be adjusted vertically; when the user moves left and right the mobile phone, the viewing angle of playing the panorama video will be adjusted horizontally; and optionally, the viewing angle of playing the panorama video may be adjusted in a direction that is opposite to the movement direction of the terminal apparatus. Moreover, the adjusting angle to adjust the viewing angle of playing the panorama video may be decided according to a motion angle or motion speed indicated by the gyroscope parameter. For example, when the terminal apparatus is rotated left by a 5° angle, the viewing angle of playing the panorama video will be rotated left by a 5° angle; and when the terminal apparatus is rotated left faster, the gyroscope parameter will change faster so that the viewing angle of playing the panorama video will be rotated more left. The handed gesture input on the touch control region and the rotation of the gyroscope may be used to the viewing angle of playing the panorama video. The method in this embodiment has flexibility of adjustment, and users may obtain good interaction experiences.

### Embodiment 5

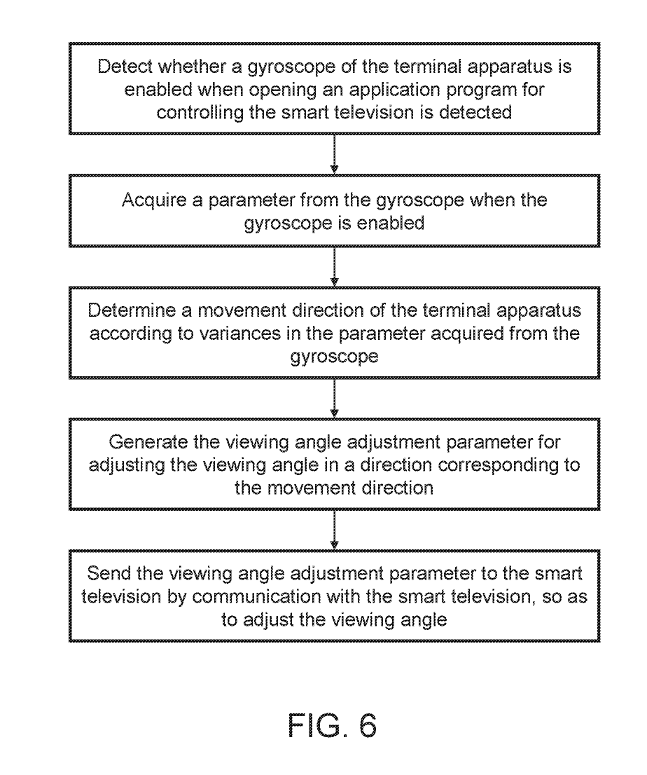

As shown in FIG. 6, a method for adjusting the viewing angle of a smart television playing a panorama video in this embodiment is applied to terminal apparatus and includes steps of:
detecting whether the gyroscope of the terminal apparatus is enabled when opening an application program installed in the smart television is detected;
acquiring a parameter from a gyroscope of the terminal apparatus when the gyroscope is enabled;
determining the movement direction of the terminal apparatus according to variances in variances in the parameter acquired from the gyroscope;
generating the viewing angle adjustment parameter for adjusting the viewing angle in a direction corresponding to the movement direction; and
sending the viewing angle adjustment parameter to the smart television by the communication with the smart television, so as to adjust the viewing angle.

In this embodiment, the viewing angle may be adjusted by the change of the gyroscope parameter as the terminal apparatus moves. For example, when a user moves the terminal apparatus up and down, the gyroscope parameter will change so that the viewing angle will be adjusted up and down; when the user moves a mobile phone left and right so that the viewing angle will be adjusted left and right; or, the viewing angle may be adjusted in a direction opposite to the movement direction of the terminal apparatus. Moreover, the adjusting angle to adjust the viewing angle of playing the panorama video may be adjusted according to the rotating angle and motion speed indicated by the gyroscope parameter. For example, when the terminal apparatus is rotated left by a 5° angle so that the viewing angle will be rotated left by a 5° angle; and when the terminal apparatus is rotated left more fast, the gyroscope parameter will change more fast so that the viewing angle will be adjusted more left. The method in this embodiment may has flexibility of adjustment, and users may obtain good interaction experiences.

### Embodiment 6

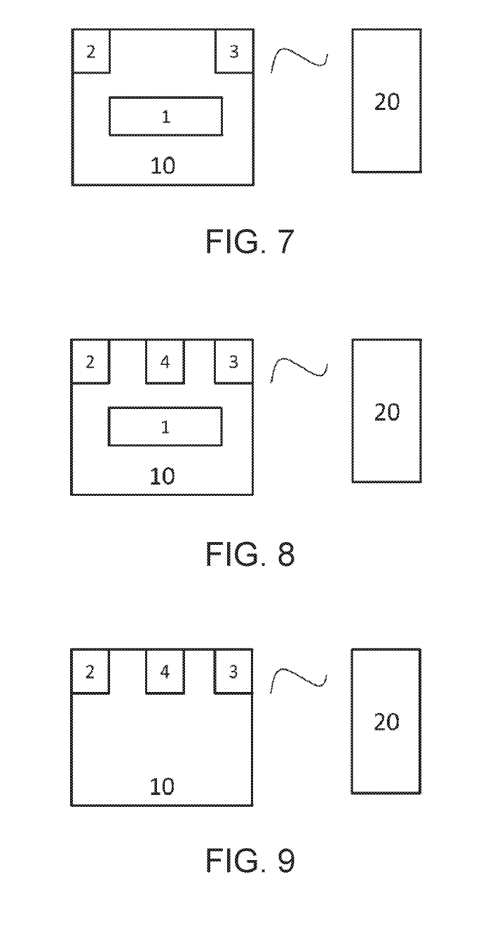

As shown in FIG. 7, a electronic apparatus of adjusting the viewing angle of a smart television 20 playing a panorama video in this embodiment includes a terminal apparatus 10, and the terminal apparatus 10 particularly includes:
a touch control region display module 1 configured to display a touch control region for adjusting the viewing angle when opening an application program for controlling the smart television 20 is detected;
a handed gesture input detecting module 2 configured to detect a handed gesture input onto the touch control region to determine a viewing angle adjustment parameter corresponding to the detected handed gesture input; and
a parameter transmission module 3 configured to send the viewing angle adjustment parameter to the smart television 20 by the communication, so as to adjust the viewing angle.

In the above electronic apparatus, the communication may be bluetooth communication or connecting the internet through WiFi. For example, the terminal apparatus 10 and the smart television 20 are connected to the network, and the preset port of the terminal apparatus 10 is monitored through the TCP point-to-pint communication between the smart television 20 and the terminal apparatus 10, to receive the control parameter from the terminal apparatus 10. In the above electronic apparatus, the handed gesture input detecting module 2 is connected to the parameter transmission module 3; the handed gesture input detecting module 2 is connected to the touch control region display module 1 so that the handed gesture input onto the touch control region can be sensed to adjust the display of the touch control region display module 1.

### Embodiment 7

A electronic apparatus of adjusting the viewing angle of the smart television 20 playing a panorama video in this embodiment is similar to the electronic apparatus in the Embodiment 6, and however, the handed gesture input detecting module 2 includes:
a slide detection sub module configured to determine a sliding parameter indicating at least the sliding direction of a slide when the slide onto the touch control region is detected; and
a first parameter generation sub module configured to generate a viewing angle adjustment parameter for adjusting the viewing angle in a direction corresponding to the sliding parameter.
wherein the sliding parameter may further indicate a sliding speed, a sliding distance and so on.

In this embodiment, the electronic apparatus adjusts the viewing angle of playing the panorama video according to a slide on the touch control region. For example, when a user's single finger slides up and down, left and right on the touch screen, the touch screen will catch a parameter related to the single finger gesture so that the viewing angle of playing the panorama video will be shifted up and down, left and right according to the single finger gesture;

alternatively, the viewing angle of playing the panorama video will be shifted in a direction opposite to the sliding direction. After the sliding direction is confirmed, a preset adjustment parameter indicating a direction that is the same as or opposite to the sliding direction is produced. Optionally, the adjustment parameter may be adjusted according to a preset adjustment level. Optionally, a sliding distance or sliding speed may detected so that the adjustment parameter is decided according to the detected sliding distance or sliding speed; and for example, faster sliding or longer sliding distance leads to a larger adjustment parameter. The electronic apparatus has flexibility of adjustment, and users may obtain good interaction experiences.

### Embodiment 8

A electronic apparatus of adjusting the viewing angle of the smart television 20 playing a panorama video in this embodiment is similar to the electronic apparatus in the Embodiment 6, and however, the handed gesture input detecting module 2 includes:
a second parameter generation sub module configured to generate a viewing angle adjustment parameter for magnifying the viewing angle when a multi-finger (i.e. two or more than two fingers) zoom-in gesture onto the touch control region is detected; and
a third parameter generation sub module configured to generate a viewing angle adjustment parameter for minifying the viewing angle when a multi-finger (i.e. two or more than two fingers) zoom-out gesture onto the touch control region is detected.

In this embodiment, the electronic apparatus adjusts the viewing angle according to a multi-finger gesture on the touch control region. For example, such a multi-finger gesture is a multi-finger zoom-out gesture or a multi-finger zoom-in gesture; when a multi-finger zoom-out gesture is sensed, the viewing angle will be zoomed in so that the user can see an enlarged space of a wider viewing angle on TV; and when a multi-finger zoom-in gesture is sensed, the viewing angle will be zoomed out so that the user can see a shrank space of a narrow viewing angle on TV. Moreover, a magnification or a minification of the viewing angle may be adjusted according to the strength of a multi-finger operation as well as the preset strength, or may be adjusted according to a ratio of an coordinate of starting a multi-finger operation to a coordinate of finishing the multi-finger operation (i.e. the initial distance between two fingers to the final distance between the two fingers). The electronic apparatus has flexibility of adjustment, and users may obtain good interaction experiences.

### Embodiment 9

As shown in FIG. 8, a electronic apparatus of adjusting the viewing angle of the smart television 20 playing panorama videos in this embodiment is similar to the electronic apparatus in the Embodiment 6, and however, this electronic apparatus further includes:
a gyroscope detecting module 4 configured to detect whether a gyroscope of the terminal apparatus 10 is enabled;
an acquiring module configured to acquire a parameter from the gyroscope when the gyroscope is enabled;
a determination module configured to determine the movement direction of the terminal apparatus 10 according to variances in the parameter acquired from the gyroscope; and
a parameter generating module configured to generate the viewing angle adjustment parameter for adjusting the viewing angle in a direction corresponding to the movement direction.

In this embodiment, the electronic apparatus adjusts the viewing angle of playing the panorama video according to the change in the gyroscope parameter caused by the movement of the terminal apparatus 10. For example, when the user moves up and down the terminal apparatus 10, the gyroscope parameter will change so that the viewing angle will be adjusted up and down; when the user moves the mobile left and right, the viewing angle will be adjusted left and right; or, the viewing angle may be adjusted in a direction that is opposite to the movement direction of the terminal apparatus. Moreover, the adjusting angle to adjust the viewing angle may be adjusted according to a motion angle or motion speed indicated by the gyroscope parameter. For example, when the terminal apparatus 10 is rotated left by a 5° angle, the viewing angle will be rotated left by a 5° angle; and when the terminal apparatus 10 is rotated left faster, the gyroscope parameter will change faster so that the viewing angle will be rotated more left. Both the handed gesture input on the touch control region and the rotation of the gyroscope may be used to adjust the viewing angle. The electronic apparatus has flexibility of adjustment, and users may obtain good interaction experiences.

### Embodiment 10

In this embodiment, as shown in FIG. 9, a terminal apparatus 10 of a electronic apparatus of adjusting the viewing angle of the smart television 20 playing panorama videos particularly includes:
a gyroscope detecting module 4 configured to detect whether a gyroscope of the terminal apparatus 10 is enabled when opening an application program for controlling the smart television 20 is detected;
an acquiring module configured to acquire a parameter from the gyroscope when the gyroscope is enabled;
a determination module configured to determine the movement direction of the terminal apparatus 10 according to variances in the parameter acquired from the gyroscope;
a parameter generating module configured to generate a viewing angle adjustment parameter for adjusting the viewing angle in a direction corresponding to the movement direction;
a parameter transmission module 3 configured to send the viewing angle adjustment parameter to the smart television 20 by the communication with the smart television 20, so as to adjust the viewing angle.

In this embodiment, the electronic apparatus may adjust the viewing angle according to the change of the gyroscope parameter caused by the movement of the terminal apparatus. For example, when the user moves up and down the terminal apparatus, the gyroscope parameter will change so that the viewing angle will be adjusted upwardly and downwardly; when the user moves the mobile phone left and right, the viewing angle will be adjusted left and right; or, the viewing angle may be adjusted in a direction opposite to the movement direction of the terminal apparatus. Furthermore, a motion angle or motion speed indicated by the gyroscope parameter may be used to decide an adjusting angle to adjust the viewing angle. For example, when the terminal apparatus is rotated left by a 5° angle, the viewing angle will be rotated left by a 5° angle; and when the terminal apparatus is rotated left faster, the gyroscope parameter will change faster so that the viewing angle will be rotated more left. The electronic apparatus has flexibility of adjustment, and users may obtain good interaction experiences.

The above embodiments employs the touch screen and gyroscope of the terminal apparatus, WiFi network, the communication module of a smart television, and bluetooth to transmit parameters, so as to permit the terminal apparatus to adjust the viewing angle as the smart television plays a panorama video.

In addition, an embodiment of the disclosure may embody the foregoing modules by a hardware processor.

An embodiment of the disclosure provides a mobile terminal, which includes the electronic apparatus of adjusting the viewing angle of a smart television playing a panorama video in any of the Embodiments 6 to 9, or includes the electronic apparatus of adjusting the viewing angle of a smart television playing a panorama video in the Embodiment 10.

The described apparatus embodiment is merely exemplary. The units described as separate parts may or may not be physically separate, and parts displayed as units may or may not be physical units, that is, may be located in one position, or may be distributed on a plurality of network units. A part or all of the modules may be selected according to actual needs to achieve the objectives of the solutions of the embodiments. A person of ordinary skill in the art may understand and implement the technical solution without creative works.

### Embodiment 11

This embodiment provides a non-volatile computer storage medium storing computer-executable instructions that are executed to perform the method of adjusting a viewing angle of a smart television playing a panorama video in any of the above method embodiments. Particularly, the computer-executable instructions are executed to perform steps of:
displaying a touch control region for adjusting the viewing angle when opening an application program for controlling the smart television is detected;
detecting a handed gesture input onto the touch control region to determine a viewing angle adjustment parameter corresponding to the detected handed gesture input; and
sending the viewing angle adjustment parameter to the smart television by communication with the smart television, so as to adjust the viewing angle.

### Embodiment 12

This embodiment provides another non-volatile computer storage medium storing computer-executable instructions that are executed to perform the method of adjusting a viewing angle of a smart television playing a panorama video in any of the above method embodiments. Particularly, the computer-executable instructions are executed to perform steps of:
detecting whether a gyroscope of the terminal apparatus is enabled when opening an application program for controlling the smart television is detected;
acquiring a parameter from the gyroscope when the gyroscope is enabled;
determining the movement direction of the terminal apparatus according to variances in the parameter acquired from the gyroscope;
generating a viewing angle adjustment parameter for adjusting the viewing angle of a smart television playing a panorama video in a direction corresponding to the movement direction;
sending the viewing angle adjustment parameter to the smart television by the communication with the smart television, so as to adjust the viewing angle.

### Embodiment 13

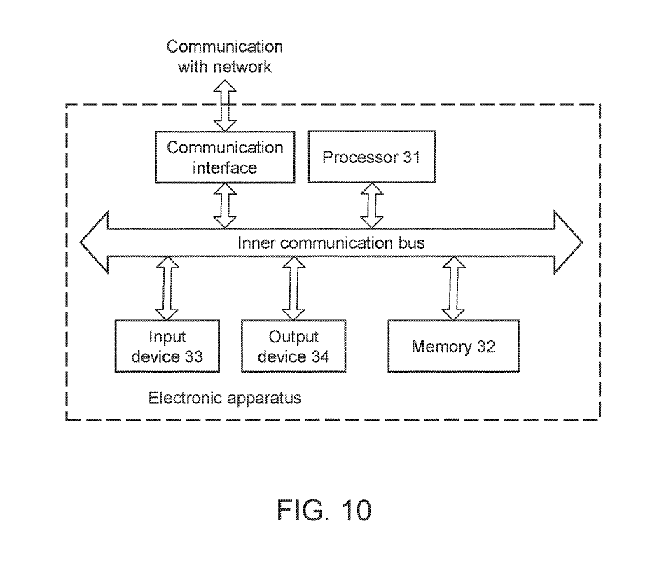

As shown in FIG. 10, this embodiment provides an electronic apparatus of adjusting a viewing angle of a smart television playing a panorama video, and the apparatus includes:
one or more processors 31 and a memory 32,
   the memory 32 storing instructions executable by the at least one processor 31 to execute steps of:displaying a touch control region for adjusting the viewing angle when opening an application program for controlling the smart television is detected;
   detecting a handed gesture input onto the touch control region to determine a viewing angle adjustment parameter corresponding to the detected handed gesture input; and
   sending the viewing angle adjustment parameter to the smart television by communication with the smart television, so as to adjust the viewing angle.

Optionally, for the step of detecting the handed gesture input onto the touch control region to determine the viewing angle adjustment parameter corresponding to the detected handed gesture input, the processor particularly performs steps of: determining a sliding parameter indicating at least the sliding direction of the slide when a slide onto the touch control region is detected; and generating the viewing angle adjustment parameter for adjusting the viewing angle in a direction corresponding to the sliding parameter.

Wherein for the step of generating the viewing angle adjustment parameter for adjusting the viewing angle in the direction corresponding to the sliding parameter, the processor particularly performs step of: generating the viewing angle adjustment parameter for adjusting the viewing angle in a direction that is the same as or opposite to the sliding direction indicated by the sliding parameter.

Optionally, for the step of detecting the handed gesture input onto the touch control region to determine the viewing angle adjustment parameter corresponding to the detected handed gesture input, the processor particularly performs steps of: generating the viewing angle adjustment parameter for magnifying the viewing angle when a multi-finger zoom-in gesture onto the touch control region is detected; and generating the viewing angle adjustment parameter for minifying the viewing angle when a multi-finger zoom-out gesture onto the touch control region is detected.

FIG. 31 exemplarily shows one processor 31.

The electronic apparatus of adjusting a viewing angle of a smart television playing a panorama video can further include: an input device 33 and an output device 34.

The processor 31, the memory 32, the input device 33 and the output device 34 can be connected by a bus or other connection manners, and FIG. 31 exemplarily shows the case of a connection manner of bus.

The memory 32 as a non-volatile computer-readable storage medium can be used for storing a non-volatile software program, non-volatile computer-executable program and module, such as program instructions/ module corresponding to the method of adjusting a viewing angle of a smart television playing a panorama video in this embodiment. The processor 31 executes a variety of function applications and the data process of a server by running the non-volatile software program, instructions and module stored in the memory 32, to carry out the method of adjusting a viewing angle of a smart television playing a panorama video in the above method embodiments.

The memory 32 can include a program storage area and a data storage area, wherein the program storage area can store an operating system and an application program required by at least one function; the data storage area can store the data created according to the use of a device of adjusting a viewing angle of a smart television playing a panorama video. Moreover, the memory 32 can include a high speed random-access storage, and further include a non-volatile memory, such as at least one disk storage member, at least one flash memory member and other non-volatile solid state storage member. In some embodiments, the memory 32 can be selected from memories having a remote connection with the processor 31, and these remote memories can be connected to a device of adjusting a viewing angle of a smart television playing a panorama video by a network. The aforementioned network includes, but not limited to, internet, intranet, local area network, mobile communication network and combination thereof

The input device 33 can receive digital or character information, and generate a key signal input corresponding to the user setting and the function control of a device of adjusting a viewing angle of a smart television playing a panorama video. The output device 34 can include a display apparatus such as a screen.

The one or more modules are stored in the memory 32, and the one or more modules execute a method of adjusting a viewing angle of a smart television playing a panorama video in any of the above method embodiments when executed by the one or more processors 31.

The technical solutions and the function and connection of each module in this electronic apparatus correspond to the related features and technical solutions in the embodiments shown in FIG. 2˜FIG. 5, and the lack herein can be referred to the embodiments in FIG. 2˜FIG. 5.

### Embodiment 14

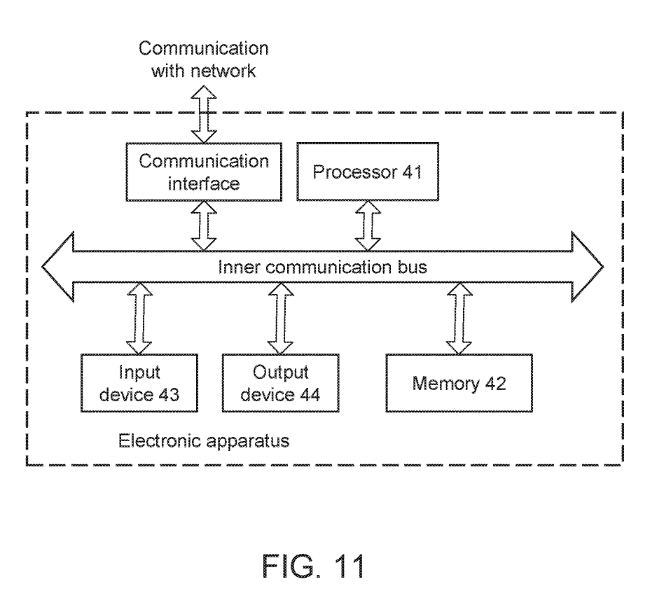

As shown in FIG. 11, this embodiment provides another electronic apparatus of adjusting a viewing angle of a smart television playing a panorama video, and the apparatus includes:
one or more processors 41 and a memory 42,
the memory 42 storing instructions executable by the at least one processor 41 to execute steps of:
   detecting whether a gyroscope of the terminal apparatus is enabled when opening an application program for controlling the smart television is detected;
   acquiring a parameter from the gyroscope when the gyroscope is enabled;
   determining the movement direction of the terminal apparatus according to variances in the parameter acquired from the gyroscope;
   generating a viewing angle adjustment parameter for adjusting the viewing angle of a smart television playing a panorama video in a direction corresponding to the movement direction;
   sending the viewing angle adjustment parameter to the smart television by the communication with the smart television, so as to adjust the viewing angle.

FIG. 41 exemplarily shows one processor 41.

The electronic apparatus of adjusting a viewing angle of a smart television playing a panorama video can further include: an input device 43 and an output device 44.

The processor 41, the memory 42, the input device 43 and the output device 44 can be connected by a bus or other connection manners, and FIG. 41 exemplarily shows the case of a connection manner of bus.

The memory 42 as a non-volatile computer-readable storage medium can be used for storing a non-volatile software program, non-volatile computer-executable program and module, such as program instructions/ module corresponding to the method of adjusting a viewing angle of a smart television playing a panorama video in this embodiment. The processor 41 executes a variety of function applications and the data process of a server by running the non-volatile software program, instructions and module stored in the memory 42, to carry out the method of adjusting a viewing angle of a smart television playing a panorama video in the above method embodiments.

The memory 42 can include a program storage area and a data storage area, wherein the program storage area can store an operating system and an application program required by at least one function; the data storage area can store the data created according to the use of a device of adjusting a viewing angle of a smart television playing a panorama video. Moreover, the memory 42 can include a high speed random-access storage, and further include a non-volatile memory, such as at least one disk storage member, at least one flash memory member and other non-volatile solid state storage member. In some embodiments, the memory 42 can be selected from memories having a remote connection with the processor 41, and these remote memories can be connected to a device of adjusting a viewing angle of a smart television playing a panorama video by a network. The aforementioned network includes, but not limited to, internet, intranet, local area network, mobile communication network and combination thereof

The input device 43 can receive digital or character information, and generate a key signal input corresponding to the user setting and the function control of a device of adjusting a viewing angle of a smart television playing a panorama video. The output device 44 can include a display apparatus such as a screen.

The one or more modules are stored in the memory 42, and the one or more modules execute a method of adjusting a viewing angle of a smart television playing a panorama video in any of the above method embodiments when executed by the one or more processors 41.

The technical solutions and the function and connection of each module in this electronic apparatus correspond to the related features and technical solutions in the embodiments shown in FIG. 6, and the lack herein can be referred to the embodiments in FIG. 6.

The mobile terminal provided in embodiments of the present application can also include the electronic apparatus and nonvolatile computer storage medium of adjusting a viewing angle of a smart television playing a panorama video in any of the above embodiments.

As will be understood by those skilled in the art, various exemplary logic blocks, modules, circuits and algorithm steps described in combination with the disclosure herein can be implemented as electronic hardware, computer software or a combination thereof. In order to clearly describe such interchangeability of hardware and software, general description has been provided in terms of functions of various schematic components, blocks, modules, circuits and steps. Whether such functions are implemented as software or hardware depends on specific applications and design constraints applied to the whole system. Those skilled in the art can implement the functions in various manners for each specific application, but the manner of implementation should not be construed as outside the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a server.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general or dedicated computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a general or dedicated computer or a general or dedicated processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blue-ray disc where disks usually reproduce data magnetically, while discs reproduce data optically with lasers. Combinations of the above should also be included within the scope of computer-readable media.

The disclosed is exemplary embodiments, and it should be noted that various alteration and modification may be made without departing the scope of the present disclosure which is defined by the claims. The functions, steps and/or operations of the method claims according to the described embodiments of the present disclosure, may not necessarily be performed in a particular order. In addition, although elements of the present disclosure may be described or prescribed in a single form, multiple forms may also be devised, unless the single form is explicitly prescribed.

It can be understood that as used herein, the singular forms “a,” “an,” and “the” are intended to include the plural forms unless the content clearly indicates otherwise. It should also be understood that the use herein “and/or” is intended to include any and all possible combinations of one or more of the associated listed items.

The number of the aforementioned embodiments of the present invention is only used for description rather than for representing advantages or disadvantages.

Those of ordinary skill will be appreciated that all or part of the steps to achieve the above-described embodiment may be accomplished by hardware, or by a program instructing relevant hardware, the program may be stored in a computer readable storage medium, said mentioned storage medium may be a read-only memory, magnetic or optical disk.

The foregoing is only preferred embodiments of the present application only, not intended to limit the present application, references in this spirit and principle of the application, made any modifications, equivalents, improvements, etc., should be included in this application within the scope of protection.

In addition, the method in the disclosure can be embodied in a computer program executed by a CPU, and the computer program is stored in a computer-readable storage medium.

The computer program is executed by the CPU to perform the foregoing functions defined in the method in the disclosure.

Also, the foregoing methods and system units may be carried out by a controller and a computer-readable storage medium storing a computer program for programming the controller to perform the foregoing steps or unit functions.

It should be understand that the computer-readable storage medium (e.g. a memory) in the disclosure may be a volatile memory or a non-volatile memory, or may include a volatile memory and a non-volatile memory. Instances of the non-volatile memory are not limited to include a read-only memory (ROM), a programmable ROM (PROM), an electrically PROM (EPROM), an electrically erasable PROM (EEPROM) and a flash memory. Instances of the volatile memory are not limited to include a random-access memory (RAM) that may be used as an external cache memory. The RAM is not limited to be a variety of exemplary types, such as a synchronous RAM (DRAM), a dynamic RAM (DRAM), a synchronous DRAM (SDRAM), a double data rate SDRAM (DDR SDRAM), an enhanced SDRAM (ESDRAM), a synchronous link DRAM (SLDRAM) and a direct RambusRAM (DRRAM). Storage equipment in the disclosure is not limited to include these types and other suitable types of memories.

What is claimed is:

1. A method of adjusting a viewing angle of a smart television playing a panorama video, and the method applied to terminal apparatus and comprising steps of:
displaying a touch control region for adjusting the viewing angle when opening an application program for controlling the smart television is detected;
detecting a handed gesture input onto the touch control region to determine a viewing angle adjustment parameter corresponding to the detected handed gesture input; and
sending the viewing angle adjustment parameter to the smart television by communication with the smart television, so as to adjust the viewing angle.

2. The method according to claim 1, wherein the step of detecting the handed gesture input onto the touch control region to determine the viewing angle adjustment parameter corresponding to the detected handed gesture input comprises steps of:
determining a sliding parameter indicating at least a sliding direction of the slide when a slide on the touch control region is detected; and
generating the viewing angle adjustment parameter for adjusting the viewing angle in a direction corresponding to the sliding parameter.

3. The method according to claim 2, wherein the step of generating the viewing angle adjustment parameter for adjusting the viewing angle in the direction corresponding to the sliding parameter comprises:
generating the viewing angle adjustment parameter for adjusting the viewing angle in a direction that is opposite to or the same as the sliding direction indicated by the sliding parameter.

4. The method according to claim 1, wherein the step of detecting the handed gesture input onto the touch control region to determine the viewing angle adjustment parameter corresponding to the detected handed gesture input comprises:
generating the viewing angle adjustment parameter for magnifying the viewing angle when a multi-finger zoom-in gesture onto the touch control region is detected;
generating the viewing angle adjustment parameter for minifying the viewing angle when a multi-finger zoom-out gesture onto the touch control region is detected.

5. The method according to claim 1, wherein after the step of displaying the touch control region when opening the application program is detected, the method further comprises:
detecting whether a gyroscope of the terminal apparatus is enabled;
acquiring a parameter from the gyroscope when the gyroscope is enabled;
determining a movement direction of the terminal apparatus according to variances in the parameter acquired from the gyroscope;
generating the viewing angle adjustment parameter for adjusting the viewing angle in a direction corresponding to the movement direction.

6. A method of adjusting a viewing angle of a smart television playing a panorama video, and the method applied to terminal apparatus and comprising steps of:
detecting whether a gyroscope of the terminal apparatus is enabled when opening an application program for controlling the smart television is detected;
acquiring a parameter from the gyroscope when the gyroscope is enabled;
determining a movement direction of the terminal apparatus according to variances in the parameter acquired from the gyroscope;
generating a viewing angle adjustment parameter for adjusting the viewing angle in a direction corresponding to the movement direction; and
sending the viewing angle adjustment parameter to the smart television by communication with the smart television, so as to adjust the viewing angle.

7. A nonvolatile computer storage medium storing computer-executable instructions that are configured to executed steps of:
displaying a touch control region for adjusting the viewing angle when opening an application program for controlling the smart television is detected;
detecting a handed gesture input onto the touch control region to determine a viewing angle adjustment parameter corresponding to the detected handed gesture input; and
sending the viewing angle adjustment parameter to the smart television by communication with the smart television, so as to adjust the viewing angle.

8. The nonvolatile computer storage medium according to claim 7, wherein the step of detecting the handed gesture input onto the touch control region to determine the viewing angle adjustment parameter corresponding to the detected handed gesture input comprises:
determining a sliding parameter indicating at least a sliding direction of the slide when a slide on the touch control region is detected; and
generating the viewing angle adjustment parameter for adjusting the viewing angle in a direction corresponding to the sliding parameter.

9. The nonvolatile computer storage medium according to claim 8, wherein the step of generating the viewing angle adjustment parameter for adjusting the viewing angle in the direction corresponding to the sliding parameter comprises:
generating the viewing angle adjustment parameter for adjusting the viewing angle in a direction that is opposite to or the same as the sliding direction indicated by the sliding parameter.

10. The nonvolatile computer storage medium according to claim 7, wherein the step of detecting the handed gesture input onto the touch control region to determine the viewing angle adjustment parameter corresponding to the detected handed gesture input comprises:
generating the viewing angle adjustment parameter for magnifying the viewing angle when a multi-finger zoom-in gesture onto the touch control region is detected;
generating the viewing angle adjustment parameter for minifying the viewing angle when a multi-finger zoom-out gesture onto the touch control region is detected.

11. The nonvolatile computer storage medium according to claim 7, wherein after the touch control region for adjusting the viewing angle is displayed when opening the application program is detected, the computer-executable instructions are further configured to execute steps of:
detecting whether a gyroscope of the terminal apparatus is enabled;
acquiring a parameter from the gyroscope when the gyroscope is enabled;
determining a movement direction of the terminal apparatus according to variances in the parameter acquired from the gyroscope;
generating a viewing angle adjustment parameter for adjusting the viewing angle in a direction corresponding to the movement direction.

12. A nonvolatile computer storage medium storing computer-executable instructions that are configured to execute steps of:
detecting whether a gyroscope of the terminal apparatus is enabled when opening an application program for controlling the smart television is detected;
acquiring a parameter from the gyroscope when the gyroscope is enabled;
determining a movement direction of the terminal apparatus according to variances in the parameter acquired from the gyroscope;
generating a viewing angle adjustment parameter for adjusting the viewing angle in a direction corresponding to the movement direction; and
sending the viewing angle adjustment parameter to the smart television by communication with the smart television, so as to adjust the viewing angle.

13. An electronic apparatus of adjusting a viewing angle of a smart television playing a panorama video, and the electronic apparatus comprising:
at least one processor; and,
a memory for communicating with the at least one processor; wherein,
the memory storing instructions executable by the at least one processor to execute steps of:
displaying a touch control region for adjusting the viewing angle when opening an application program for controlling the smart television is detected;
detecting a handed gesture input onto the touch control region to determine a viewing angle adjustment parameter corresponding to the detected handed gesture input; and
sending the viewing angle adjustment parameter to the smart television by communication with the smart television, so as to adjust the viewing angle.

14. The electronic apparatus according to claim 13, wherein the step of detecting the handed gesture input onto the touch control region to determine the viewing angle adjustment parameter corresponding to the detected handed gesture input comprises:
determining a sliding parameter indicating at least a sliding direction of the slide when a slide on the touch control region is detected; and
generating the viewing angle adjustment parameter for adjusting the viewing angle in a direction corresponding to the sliding parameter.

15. The electronic apparatus according to claim 14, wherein the step of generating the viewing angle adjustment parameter for adjusting the viewing angle in the direction corresponding to the sliding parameter comprises:
generating the viewing angle adjustment parameter for adjusting the viewing angle in a direction that is opposite to or the same as the sliding direction indicated by the sliding parameter.

16. The electronic apparatus according to claim 13, wherein the step of detecting the handed gesture input onto the touch control region to determine the viewing angle adjustment parameter corresponding to the detected handed gesture input comprises:
generating the viewing angle adjustment parameter for magnifying the viewing angle when a multi-finger zoom-in gesture onto the touch control region is detected;
generating the viewing angle adjustment parameter for minifying the viewing angle when a multi-finger zoom-out gesture onto the touch control region is detected.

17. The electronic apparatus according to claim 13, wherein after the touch control region for adjusting the viewing angle is displayed when opening the application program is detected, the program is further configured to execute:
detecting whether a gyroscope of the terminal apparatus is enabled;
acquiring a parameter from the gyroscope when the gyroscope is enabled;
determining a movement direction of the terminal apparatus according to variances in the parameter acquired from the gyroscope;
generating a viewing angle adjustment parameter for adjusting the viewing angle in a direction corresponding to the movement direction.

18. An electronic apparatus of adjusting a viewing angle of a smart television playing a panorama video, and the electronic apparatus comprising:
at least one processor; and,
a memory for communicating with the at least one processor; wherein,
the memory stores instructions executable by the at least one processor to execute steps of:
detecting whether a gyroscope of the terminal apparatus is enabled when opening an application program for controlling the smart television is detected;
acquiring a parameter from the gyroscope when the gyroscope is enabled;
determining a movement direction of the terminal apparatus according to variances in the parameter acquired from the gyroscope;
generating a viewing angle adjustment parameter for adjusting the viewing angle in a direction corresponding to the movement direction; and
sending the viewing angle adjustment parameter to the smart television by communication with the smart television, so as to adjust the viewing angle.
